(19) United States
(12) Patent Application Publication
(10) Pub. No.: US 2014/0305965 A1
(43) Pub. Date: Oct. 16, 2014

(54) PRODUCT BOX ASSEMBLY IN VENDING MACHINE

(71) Applicant: Hon Hai Precision Industry Co., Ltd., New Taipei (TW)

(72) Inventor: FU-KUO HUANG, New Taipei (TW)

(73) Assignee: HON HAI PRECISION INDUSTRY CO., LTD., New Taipei (TW)

(21) Appl. No.: 14/069,502

(22) Filed: Nov. 1, 2013

(30) Foreign Application Priority Data
Apr. 16, 2013 (TW) 102113458

(51) Int. Cl. G07F 11/38

(52) U.S. Cl. CPC G07F 11/38
USPC 221/287

(57) ABSTRACT

A product box assembly includes two sliding rails, and the product box is slidably mounted between the two sliding rails. Each sliding rail defines a guiding slot and a sliding slot communicating with the guiding slot. Each sliding rail includes a blocking portion located in the guiding slot. The product box includes a sliding post. The sliding post is slidable in the sliding rails. The product box is slanted relative to a horizontal plane due to gravity when restocking products in the product box. The sliding posts are latched in the guiding slots by the blocking portions when in the slanted state.

### BACKGROUND

1. Technical Field

The present disclosure relates to vending machines, and particularly to a product box assembly in a vending machine.

2. Description of Related Art

A direct-type vending machine includes a cabinet and a number of product box assemblies assembled in the cabinet. Each product box assembly includes a product box slidably attached between two sliding rails. The product box receives a number of products, and the sliding rails are secured to the cabinet. However, the product box can accidentally slide out of the sliding rails when restocking products. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a product box assembly of a vending machine.

FIG. 2 is an isometric view of a sliding rail of the product box assembly of FIG. 1.

FIG. 3 is an assembled, isometric view of the product box assembly in a first position.

FIG. 4 is similar to FIG. 3, but shows the product box assembly in a second position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

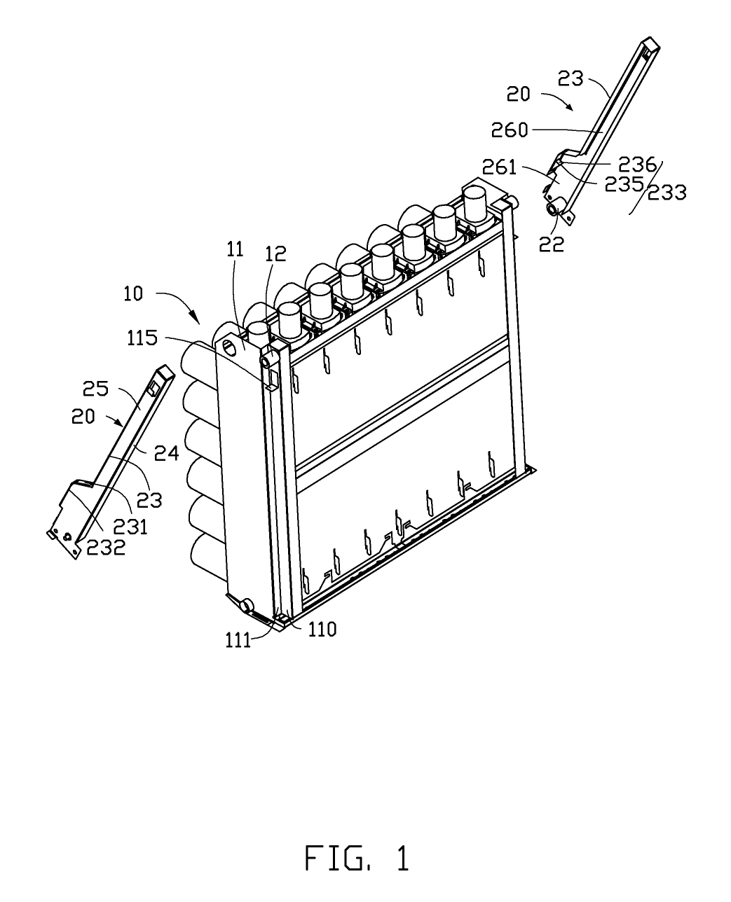

FIG. 1 shows one embodiment of a product box assembly in a vending machine. The product box assembly includes a product box 10 and two sliding rails 20. The two sliding rails 20 are secured to a cabinet of a vending machine (not shown).

The product box 10 includes two side plates 11. A first sliding plate 111 extends substantially perpendicularly from a side edge of a corresponding side plate 11. A second sliding plate 110 extends substantially perpendicularly from a side edge of a corresponding first sliding plate 111. A limiting piece 115 extends substantially perpendicularly from the second sliding plate 110. A sliding post 12 protrudes from the second sliding plate 110.

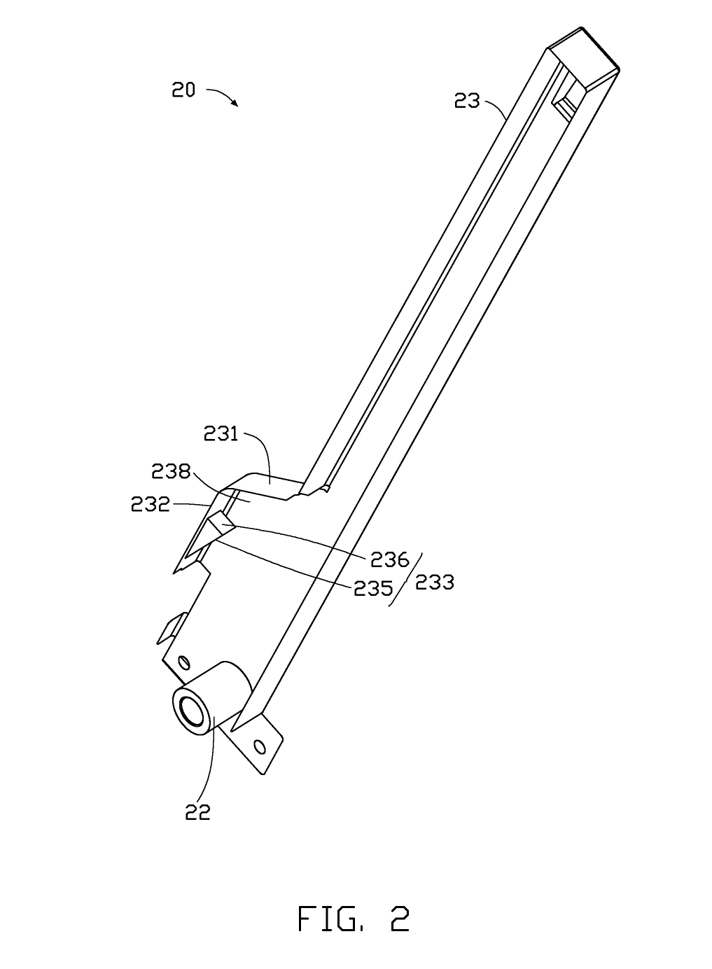

FIG. 2 shows that each sliding rail 20 includes a bottom wall 24, a first sidewall 23 extending from a first edge of the bottom wall 24, and a second sidewall 25 extending from a second edge of the bottom wall 24. A first flange 231 extends from the first sidewall 23, and a second flange 232 extends from the first flange 231. A rotating post 22 protrudes from an inner surface of the bottom wall 24. The first flange 231 defines a first obtuse angle with the first sidewall 23. The second flange 232 defines a second obtuse angle with the first flange 231. The first sidewall 23, the bottom wall 24, and the second sidewall 25 cooperatively define a sliding slot 260. The first flange 231, the second flange 232, the bottom wall 24, and the second sidewall 25 cooperatively define a guiding slot 261 communicating with the sliding slot 260. A limiting portion 233 protrudes from the second flange 232. The limiting portion 233 includes a guiding surface 235 and a blocking surface 236 connected to the guiding surface 235. The guiding surface 235 defines an obtuse angle with the second flange 232. The blocking surface 236 is substantially perpendicular to the second flange 232. A latching slot 238 is defined between the blocking surface 236 and the first flange 232.

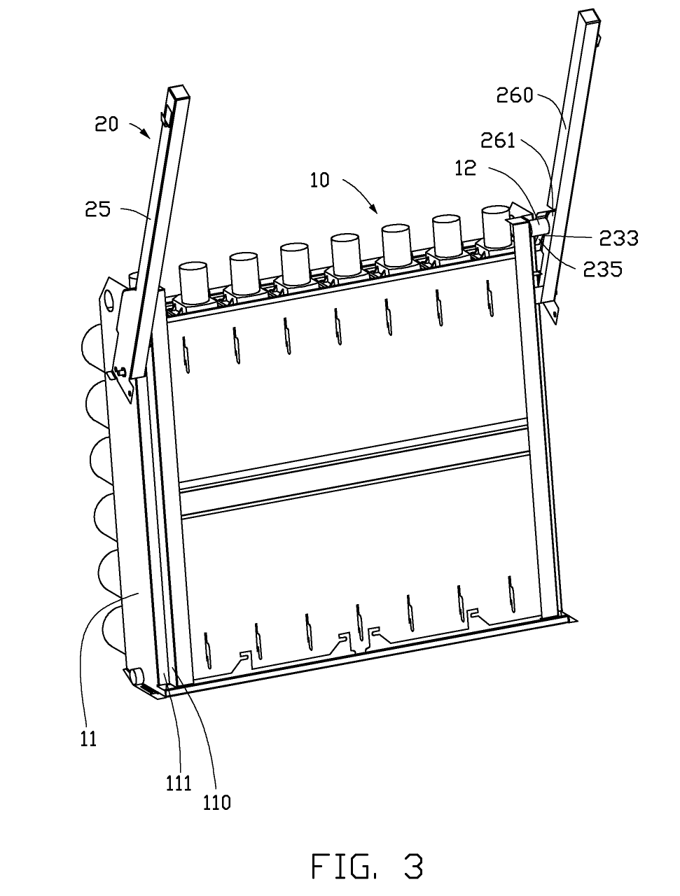

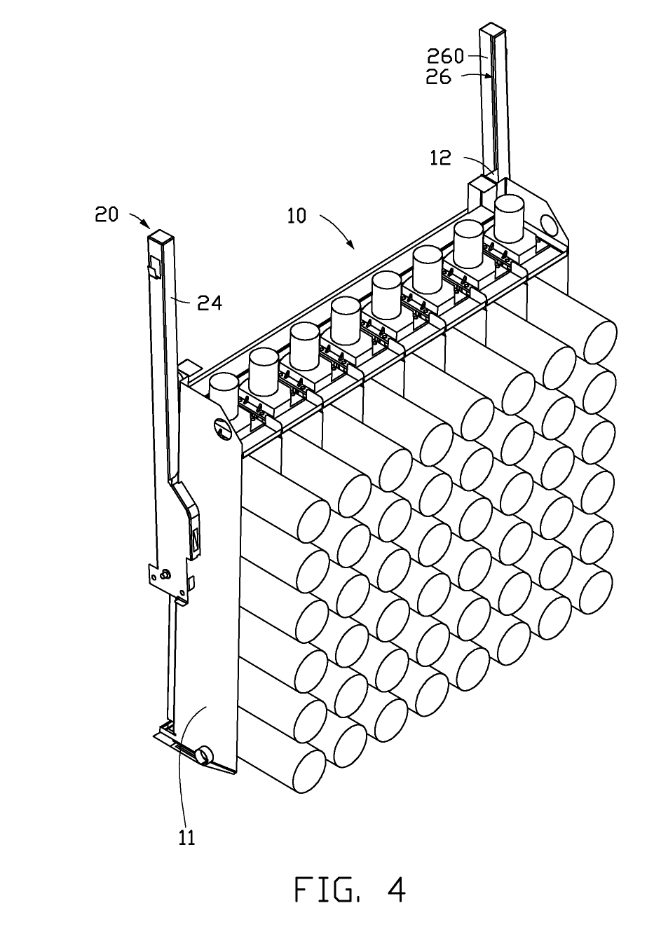

FIGS. 3 and 4 show that in assembly, the sliding posts 12 are received in corresponding guiding slots 261 of the two sliding rails 20, such that the rotating posts 22 abut the first sliding plates 111. The sliding posts 12 are slid along the guiding slots 261 and into the sliding slots 260. The sliding rails 20 are rotated about the rotating posts 22 until the sliding posts 12 are located in an end of the sliding slot 260. Therefore, the product box 10 is slidably mounted between the two sliding rails 20 in the vending machine.

To slide the product box 10 out of the vending machine to restock products, the product box 10 is slid out of the sliding slots 260 until the limiting pieces 115 abut the rotating posts 22. The product box 10 is slanted down due to gravity, and the sliding posts 12 are received in the latching slots 238 and abut the blocking surfaces 236, thereby preventing the product box 10 from sliding out of the two sliding rails 20. The product box 10 remains slanted, thereby making restocking of the products more convenient. To completely remove the product box 10 from the vending machine, the product box 10 is lifted and pulled out to remove the sliding posts 12 from the latching slots 238. Therefore, the product box 10 can be slid out of the two sliding rails 20 through the guiding slots 261.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A product box assembly, comprising:
two sliding rails, each sliding rail defining a guiding slot and a sliding slot communicating with the guiding slot; and
a product box slidably mounted between the two sliding rails, and comprising two side plates and a sliding post attached to each side plate;
wherein a width of the guiding slot is greater than a width of the sliding slot; each sliding rail comprises a blocking portion located in the guiding slot, the blocking portion comprises a guiding surface and a blocking surface connected to the guiding surface, and an acute angle is defined between the guiding surface and the blocking surface; the sliding post is slidable relative to the sliding rails between the guiding slot and the sliding slot along the guiding surface; and when the sliding post is slid from the sliding slot to the guiding slot, the product box is slanted relative to a horizontal plane due to gravity, and the sliding post is latched in the guiding slot by the blocking of the blocking surface.

2. The product box assembly of claim 1, wherein the guiding surface is slanted relative to the horizontal plane, and the blocking surface is substantially perpendicular to the horizontal plane.

3. The product box assembly of claim 1, wherein each sliding rail further comprises a rotating post in the guiding slot, the product box further comprises a first sliding plate extending from each side plate, and the rotating post abuts the first sliding plate and is slidable along the first sliding plate.

4. The product box assembly of claim 3, wherein the product box further comprises a second sliding plate extending from the first sliding plate, and a limiting piece extends from the second sliding plate; the sliding post is located on the second sliding plate; and when the sliding post is slid from the sliding slot to the guiding slot, the limiting piece abuts the rotating post.

5. The product box assembly of claim 4, wherein the first sliding plate is substantially perpendicular to the side plate, the second sliding plate is substantially perpendicular to the first sliding plate, and the limiting piece is substantially perpendicular to the second sliding plate.

6. The product box assembly of claim 1, wherein each sliding rail further comprises a bottom wall, a first sidewall extending from a first edge of the bottom wall, a first flange extending from the first sidewall, a second flange extending from the first flange, and a second sidewall extending from a second edge of the bottom wall; the guiding slot is defined cooperatively by the first flange, the second flange, the bottom wall, and the second sidewall; and the sliding slot is defined cooperatively by the first sidewall, the bottom wall, and the second sidewall.

7. The product box assembly of claim 6, wherein the blocking portion extends from the second flange, the guiding surface extends slantingly from the second flange, and the blocking surface is substantially perpendicular to the second flange.

8. The product box assembly of claim 6, wherein the first flange extends slantingly outwards from the first sidewall, and the second flange is slanted relative to the first flange; a first obtuse angel is defined between the first sidewall and the first flange, and a second obtuse angle is defined between the first flange and the second flange.

9. The product box assembly of claim 6, wherein an obtuse angle is defined between the second flange and the guiding surface.

10. The product box assembly of claim 6, wherein a latching slot is defined between the blocking surface and the second flange, and when the product box is slanted relative to the horizontal plane, the sliding post is engaged in the latching slot.

11. A product box assembly, comprising:
two sliding rails, each sliding rail defining a guiding slot and a sliding slot communicating with the guiding slot; and
a product box slidably mounted between the two sliding rails and comprising two side plates, a first sliding plate extending from each side plate, a second sliding plate extending from the second sliding plate, a limiting piece extending from the second sliding plate, and a sliding post located on the second sliding plate;
wherein a width of the guiding slot is greater than a width of the sliding slot; each sliding rail comprises a blocking portion and a rotating post located in the guiding slot; the blocking portion comprises a guiding surface and a blocking surface connected to the guiding surface, and an acute angle is defined between the guiding surface and the blocking surface; the sliding post is slidable relative to the sliding rails between the guiding slot and the sliding slot along the guiding surface; and when the sliding post is slidable relative to the sliding rails from the sliding slot to the guiding slot to abut the rotating post to the limiting piece, the product box is slanted relative to a horizontal plane due to the gravity, and the sliding post is latched in the guiding slot by the blocking of the blocking surface.

12. The product box assembly of claim 11, wherein the guiding surface is slanted relative to the horizontal plane, and the blocking surface is substantially perpendicular to the horizontal plane.

13. The product box assembly of claim 11, wherein the rotating post abuts the first sliding plate and is slidable along the first sliding plate.

14. The product box assembly of claim 11, wherein the first sliding plate is substantially perpendicular to the side plate, the second sliding plate is substantially perpendicular to the first sliding plate.

15. The product box assembly of claim 11, wherein the limiting piece is substantially perpendicular to the second sliding plate.

16. The product box assembly of claim 11, wherein each sliding rail further comprises a bottom wall, a first sidewall extending from a first edge of the bottom wall, a first flange extending from the first sidewall, a second flange extending from the first flange, and a second sidewall extending from a second edge of the bottom wall; the guiding slot is defined cooperatively by the first flange, the second flange, the bottom wall, and the second sidewall; and the sliding slot is defined cooperatively by the first sidewall, the bottom wall, and the second sidewall.

17. The product box assembly of claim 16, wherein the blocking portion extends from the second flange, the guiding surface extends slantingly from the second flange, and the blocking surface is substantially perpendicular to the second flange.

18. The product box assembly of claim 16, wherein the first flange extends slantingly outwards from the first sidewall, and the second flange is slanted relative to the first flange; a first obtuse angle is defined between the first sidewall and the first flange, and a second obtuse angle is defined between the first flange and the second flange.

19. The product box assembly of claim 16, wherein an obtuse angle is defined between the second flange and the guiding surface.

20. The product box assembly of claim 16, wherein a latching slot is defined between the blocking surface and the second flange, and when the product box is slanted relative to the horizontal plane, the sliding post is engaged in the latching slot.
